(19) United States
(12) Patent Application Publication
(10) Pub. No.: US 2026/0332054 A1
(43) Pub. Date: Oct. 22, 2026

(54) POWER CONVERSION APPARATUS

(71) Applicant: MetaPWR Electronics Co., Ltd., Shanghai (CN)

(72) Inventors: Da Jin, Shanghai (CN); Yahong Xiong, Shanghai (CN); Qinghua Su, Shanghai (CN)

(73) Assignee: MetaPWR Electronics Co., Ltd., Shanghai (CN)

(21) Appl. No.: 19/653,118

(22) Filed: Apr. 21, 2026

(30) Foreign Application Priority Data
Apr. 21, 2025 (CN) 202510501868.8

(51) Int. Cl. H02M 3/28; H02M 1/00; H02M 3/335

(52) U.S. Cl. CPC H02M 3/285; H02M 1/0064; H02M 3/33573

(57) ABSTRACT

The present application provides a power conversion apparatus, which includes a plurality of power sub-circuits. By adding auxiliary windings, coupling the high-voltage winding, the low-voltage winding, and the auxiliary winding in the same power sub-circuit on a single magnetic core to form a magnetic component, and connecting the auxiliary windings or the low-voltage windings of the power sub-circuits in series to form a closed loop, the power conversion circuit can ensure steady-state performance while also satisfying dynamic-performance requirements.

### CROSS-REFERENCE TO RELATED APPLICATION

This application claims the priority benefit of China application serial no. 202510501868.8 filed on Apr. 21, 2025. The entirety of the above-mentioned patent application is hereby incorporated by reference herein and made a part of this specification.

### BACKGROUND

### Description of Related Art

In recent years, with the development of technologies in fields such as data centers, artificial intelligence, and supercomputers, an increasing number of powerful ASICs have been adopted, such as CPUs, GPUs, machine learning accelerators, network switches, and servers. These devices consume large amounts of current, for example, up to thousands of amperes. To satisfy the requirement for rapid response to load transients, the current industry practice is to employ a two-stage converter, namely, a front-stage converter, which converts a 48 V bus into a 12 V bus or an even lower-voltage bus, plus a rear-stage voltage regulator. The voltage regulator often adopts multiphase buck converters connected in an interleaved parallel configuration together with inversely coupled inductors, thereby readily achieving rapid response to load transients, so as to implement voltage conversion from 48 V to 1 V.

However, due to the existence of the low-voltage bus, such as the 12 V bus, relatively large conduction losses are generated, resulting in relatively low overall system efficiency and relatively complicated application.

A second approach is to employ a single-stage power converter, in which the 12 V bus is eliminated and the 48 V input is directly converted to 1 V or an even lower voltage. Although the power conversion components of the single-stage converter have relatively high conversion efficiency and relatively high power density, the transformer and output inductor of the single-stage converter are often integrated into the same magnetic component. As a result, the magnetic component is difficult to optimize in design, and it is not possible to simultaneously achieve relatively low conduction loss and relatively good dynamic performance.

Therefore, how to develop a power conversion component and an electronic apparatus capable of solving the problems faced by the prior art has become an urgent issue to be addressed in this field.

### SUMMARY

In view of the above, one of the objectives of the application is to provide a power conversion apparatus, comprising a high-voltage circuit and N low-voltage circuits, wherein N is an integer greater than or equal to 2.

Each of the low-voltage circuits comprises a low-voltage winding and a low-voltage switch, the low-voltage winding comprises a first low-voltage winding and a second low-voltage winding electrically connected in series

The high-voltage circuit comprises high-voltage windings and high-voltage switches, wherein the number of the high-voltage windings is 2N.

The power conversion apparatus further comprising auxiliary windings, wherein the number of the auxiliary windings is (2N−1), and the (2N−1) auxiliary windings are electrically connected in series in sequence to form an auxiliary winding branch;

One of the high-voltage windings, one of the first low-voltage windings, and one of the auxiliary windings are coupled to form a first transformer;

One of the high-voltage windings, one of the second low-voltage windings, and one of the auxiliary windings are coupled to form a second transformer;

And one of the high-voltage windings and one of the second low-voltage windings are coupled to form a third transformer.

Preferably, the auxiliary winding branch and the second low-voltage winding in the third transformer are connected in series to form an auxiliary winding series loop.

Preferably, the low-voltage circuit comprises a low-voltage terminal, the low-voltage terminal comprises a low-voltage positive terminal and a low-voltage negative terminal.

A series connection point between the first low-voltage winding and the second low-voltage winding is electrically connected to the low-voltage positive terminal, and the first low-voltage winding and the second low-voltage winding are electrically connected to the low-voltage negative terminal through the low-voltage switch.

Preferably, the N low-voltage circuits are electrically connected in parallel and connected across the low-voltage positive terminal and the low-voltage negative terminal.

Preferably, the high-voltage circuit comprises M high-voltage sub-circuits, M being an integer greater than or equal to 1.

Each of the high-voltage sub-circuits comprises 2×N/M high-voltage windings and two high-voltage bridge arms, each of the two high-voltage bridge arms comprises a bridge arm midpoint, and the 2×N/M high-voltage windings being electrically connected in series and connected across the bridge arm midpoints of the two high-voltage bridge arms.

Preferably, the power conversion apparatus comprises a high-voltage terminal, the high-voltage terminal comprises a high-voltage positive terminal and a high-voltage negative terminal, and the M high-voltage sub-circuits are electrically connected in parallel and connected across the high-voltage positive terminal and the high-voltage negative terminal.

Preferably, the high-voltage bridge arms are respectively a switch bridge arm and a capacitor bridge arm, the switch bridge arm comprises two high-voltage switches connected in series, and the capacitor bridge arm comprises two capacitors connected in series.

Preferably, the high-voltage bridge arms are switch bridge arms, and each switch bridge arm comprises two high-voltage switches connected in series.

Preferably, in the first transformer, a first end of the high-voltage winding, a first end of the first low-voltage winding, and a first end of the auxiliary winding are corresponding polarity ends;

In the second transformer, a first end of the high-voltage winding, a first end of the second low-voltage winding, and a first end of the auxiliary winding are corresponding polarity ends;

And in the third transformer, a first end of the high-voltage winding and a first end of the second low-voltage winding are corresponding polarity ends.

Preferably, among the 2×N/M high-voltage windings connected in series, the high-voltage windings located at two ends of the series loop are respectively a first high-voltage winding and a second high-voltage winding; a first end of the first high-voltage winding and a second end of the second high-voltage winding are respectively electrically connected to the bridge arm midpoint;

A second end of the first high-voltage winding is electrically connected to a first end of an adjacent high-voltage winding, and a first end of the second high-voltage winding is electrically connected to a second end of an adjacent high-voltage winding;

And a second end of the first low-voltage winding is electrically connected to the first end of the second low-voltage winding.

Preferably, the auxiliary winding in the first transformer is a first auxiliary winding, and the auxiliary winding in the second transformer is a second auxiliary winding;

The (2N−1) auxiliary windings are electrically connected in series to form a series branch in the order of the first auxiliary winding, the second auxiliary winding, and the first auxiliary winding, wherein the first auxiliary windings located at two ends of the series branch of the (2N−1) auxiliary windings are respectively an upper first auxiliary winding and a lower first auxiliary winding;

A second end of the upper first auxiliary winding is short-circuited to a second end of the second auxiliary winding, and a first end of the lower first auxiliary winding is short-circuited to a first end of the second auxiliary winding;

For the first auxiliary winding located between the upper first auxiliary winding and the lower first auxiliary winding, a first end thereof is short-circuited to the first end of the second auxiliary winding, and a second end thereof is short-circuited to the second end of the second auxiliary winding.

Preferably, a second end of the lower first auxiliary winding is short-circuited to a second end of one second low-voltage winding, and the first end of the second low-voltage winding is short-circuited to a first end of the upper first auxiliary winding; the second low-voltage winding and the first low-voltage winding of the third transformer are in a same low-voltage circuit.

A power conversion apparatus, comprising an input positive terminal, an input negative terminal, an output positive terminal, an output negative terminal, and N power sub-circuits, each of the power sub-circuits comprises a high-voltage circuit, a low-voltage circuit, and auxiliary windings, wherein N is an integer greater than or equal to 2.

The high-voltage circuit is connected across the input positive terminal and the input negative terminal, and comprises a high-voltage switch assembly and a high-voltage winding assembly; the high-voltage switch assembly comprises at least two high-voltage switches, and each of the high-voltage switches is electrically connected to the high-voltage winding assembly; the high-voltage winding assembly comprises a first high-voltage winding and a second high-voltage winding, and a second end of the first high-voltage winding is electrically connected to a first end of the second high-voltage winding.

The low-voltage circuit is connected across the output positive terminal and the output negative terminal, and comprises a low-voltage switch assembly and a low-voltage winding assembly; the low-voltage switch assembly comprises at least two low-voltage switches, and each of the low-voltage switches is electrically connected to the low-voltage winding assembly; the low-voltage winding assembly comprises a first low-voltage winding and a second low-voltage winding, and a second end of the first low-voltage winding is electrically connected to a first end of the second low-voltage winding.

Each of the power sub-circuits from the first power sub-circuit to the (N−1)th power sub-circuit further comprises a first auxiliary winding and a second auxiliary winding; a second end of the first auxiliary winding is electrically connected to a second end of the second auxiliary winding; a first end of the last auxiliary winding in the Kth power sub-circuit is electrically connected to a first end of the first auxiliary winding in the (K+1)th power sub-circuit, where 1≤K≤(N−1).

The first high-voltage winding, the first low-voltage winding, and the first auxiliary winding are coupled to form one transformer; the second high-voltage winding, the second low-voltage winding, and the second auxiliary winding are coupled to form one transformer.

Preferably, the Nth power sub-circuit comprises a first auxiliary winding, a first end of the first auxiliary winding in the Nth power sub-circuit being electrically connected to a first end of the last auxiliary winding in the (N−1)th power sub-circuit, and a second end of the first auxiliary winding in the Nth power sub-circuit being electrically connected to a second end of the second low-voltage winding in the Nth power sub-circuit;

A first end of the first auxiliary winding in the first power sub-circuit is electrically connected to the first end of the second low-voltage winding in the Nth power sub-circuit; the first high-voltage winding, the first low-voltage winding, and the first auxiliary winding are coupled to form one transformer;

And the second high-voltage winding and the second low-voltage winding in the Nth power sub-circuit are coupled to form one transformer.

Preferably, wherein the high-voltage switch assembly comprises four high-voltage switches, the four high-voltage switches forming two switch bridge arms, the two switch bridge arms being electrically connected in parallel;

A first end of the first high-voltage winding and a second end of the second high-voltage winding are respectively electrically connected to a bridge arm midpoint;

And in the same transformer, a first end of the high-voltage winding, a first end of the low-voltage winding, and a first end of the auxiliary winding are corresponding polarity ends.

Preferably, the high-voltage circuit is a half-bridge circuit, and the half-bridge circuit comprises two series bridge arms, wherein the two series bridge arms comprise a capacitor bridge arm and a switch bridge arm;

The capacitor bridge arm comprises two capacitors, the two capacitors being electrically connected in series at a capacitor bridge arm midpoint;

The switch bridge arm comprises two switches, the two switches being electrically connected in series at a switch bridge arm midpoint;

And the high-voltage winding assembly is connected across the capacitor bridge arm midpoint and the switch bridge arm midpoint.

Preferably, the low-voltage circuit is a first low-voltage circuit, and each of the power sub-circuits further comprises a second low-voltage circuit;

The second low-voltage circuit comprises a third low-voltage winding, a fourth low-voltage winding, a third low-voltage switch, and a fourth low-voltage switch;

A first end of the third low-voltage winding is electrically connected to the third low-voltage switch, a second end of the third low-voltage winding and a first end of the fourth low-voltage winding are electrically connected to the output positive terminal, and a second end of the fourth low-voltage winding is electrically connected to the fourth low-voltage switch;

And the third low-voltage switch and the fourth low-voltage switch are electrically connected to the output negative terminal.

Preferably, the high-voltage winding assembly in each of the power sub-circuits further comprises a third high-voltage winding and a fourth high-voltage winding;

A second end of the second high-voltage winding is electrically connected to a first end of the third high-voltage winding, a second end of the third high-voltage winding is electrically connected to a first end of the fourth high-voltage winding, the high-voltage circuit comprises two series bridge arms, each of the series bridge arms comprises a bridge arm midpoint; a first end of the first high-voltage winding and a second end of the fourth high-voltage winding are respectively electrically connected to one bridge arm midpoint.

Preferably, each of the power sub-circuits from the first power sub-circuit to the (N−1)th power sub-circuit further comprises a third auxiliary winding and a fourth auxiliary winding;

A first end of the second auxiliary winding is electrically connected to a first end of the third auxiliary winding, and a second end of the third auxiliary winding is electrically connected to a second end of the fourth auxiliary winding;

A first end of the last auxiliary winding in the Kth power sub-circuit is electrically connected to a first end of the first auxiliary winding in the (K+1)th power sub-circuit; the third high-voltage winding, the third low-voltage winding, and the third auxiliary winding are coupled to form one transformer;

The fourth high-voltage winding, the fourth low-voltage winding, and the fourth auxiliary winding are coupled to form one transformer;

The Nth power sub-circuit comprises a first auxiliary winding, a second auxiliary winding and a third auxiliary winding; a second end of the first auxiliary winding is electrically connected to a second end of the second auxiliary winding; a first end of the second auxiliary winding is electrically connected to a first end of the third auxiliary winding; a second end of the third auxiliary winding is electrically connected to a second end of the fourth low-voltage winding in the Nth power sub-circuit; and a first end of the first auxiliary winding in the first power sub-circuit is electrically connected to a first end of the fourth low-voltage winding in the Nth power sub-circuit;

The second high-voltage winding, the second low-voltage winding, and the second auxiliary winding are coupled to form one transformer; the third high-voltage winding, the third low-voltage winding, and the third auxiliary winding are coupled to form one transformer; and the fourth high-voltage winding and the fourth low-voltage winding are coupled to form one transformer.

Preferably, each of the power sub-circuits further comprises a third low-voltage circuit, or comprises the third low-voltage circuit to an Mth low-voltage circuit, where M is an integer greater than 2;

The high-voltage winding assembly in each of the high-voltage circuits further comprises M high-voltage windings, the M high-voltage windings being electrically connected in series in sequence;

Each of the power sub-circuits comprises (2M−1) auxiliary windings;

And one high-voltage winding, one low-voltage winding and one auxiliary winding are coupled to form one transformer or one high-voltage winding and one low-voltage winding are coupled to form one transformer.

Compared with the prior art, the application has the following beneficial effects:

The present application provides a power conversion apparatus, which includes a plurality of power sub-circuits. By adding auxiliary windings, coupling the high-voltage winding, the low-voltage winding, and the auxiliary winding in the same power sub-circuit on a single magnetic core to form a magnetic component, and connecting the auxiliary windings or the low-voltage windings of the power sub-circuits in series to form a closed loop, the power conversion circuit can ensure steady-state performance while also satisfying dynamic-performance requirements.

### BRIEF DESCRIPTION OF THE DRAWINGS

FIG. 1 is a schematic diagram of a single-stage power conversion circuit.

FIG. 2 is a schematic diagram of full-bridge circuit.

FIG. 3 is a schematic diagram of another single-stage power conversion circuit.

### DESCRIPTION OF THE EMBODIMENTS

One of the cores of the present application is to provide a power conversion apparatus.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

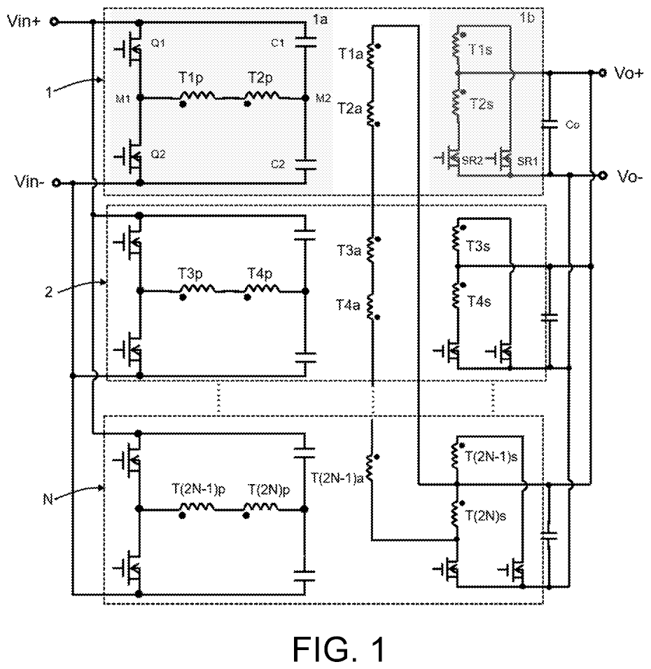

One of the core aspects of the present invention is to provide a power conversion apparatus. The present invention proposes a single-stage power conversion circuit that satisfies both high-power requirements and dynamic-performance requirements. As shown in FIG. 1, the single-stage power conversion circuit includes N power sub-circuits 1, where N≥2. The input terminals of the N power sub-circuits are electrically connected in parallel, and the output terminals thereof are electrically connected in parallel. Each power sub-circuit includes a high-voltage circuit and a low-voltage circuit 1b. In this embodiment, the high-voltage circuit is a half-bridge circuit 1a. Each half-bridge circuit 1a includes a switch bridge arm, a capacitor bridge arm, and a high-voltage winding assembly. The switch bridge arm and the capacitor bridge arm are electrically connected in parallel between an input positive terminal Vin+ and an input negative terminal Vin-. The high-voltage winding assembly is connected across a switch bridge arm midpoint and a capacitor bridge arm midpoint. The high-voltage winding assembly includes a plurality of high-voltage windings electrically connected in series. In this embodiment, MOSFETs are taken as examples of the switches for illustration, but the switches are not limited thereto.

Specifically, taking the first power sub-circuit as an example, in the half-bridge circuit 1a, the switch bridge arm includes high-voltage switches Q1 and Q2, and the high-voltage switches Q1 and Q2 are electrically connected in series at the switch bridge arm midpoint M1. The capacitor bridge arm includes capacitors C1 and C2, and the capacitors C1 and C2 are electrically connected in series at the capacitor bridge arm midpoint M2. The high-voltage winding assembly includes high-voltage windings T1p and T2p, and the high-voltage windings T1p and T2p are electrically connected in series. The high-voltage winding assembly is connected across the switch bridge arm midpoint M1 and the capacitor bridge arm midpoint M2. A first end of the high-voltage winding T1p is electrically connected to the switch bridge arm midpoint M1, a second end of the high-voltage winding T1p is electrically connected to a first end of the high-voltage winding T2p, and a second end of the high-voltage winding T2p is electrically connected to the capacitor bridge arm midpoint M2.

The low-voltage circuit 1b includes synchronous rectifier switches, namely low-voltage switches, SR1 and SR2, a first low-voltage winding T1s, and a second low-voltage winding T2s. A first end of the first low-voltage winding T1s is electrically connected to a drain of the synchronous rectifier switch SR1. A second end of the first low-voltage winding T1s and a first end of the second low-voltage winding T2s are electrically connected to an output positive terminal Vo+. A second end of the second low-voltage winding T2s is electrically connected to a drain of the synchronous rectifier switch SR2. A source of the synchronous rectifier switch SR1 and a source of the synchronous rectifier switch SR2 are electrically connected to an output negative terminal Vo−. An output capacitor Co is connected across the output positive terminal Vo+ and the output negative terminal Vo−.

Without considering dead-time settings of gate drive signals, when the high-voltage switch Q1 is turned on, the synchronous rectifier switch SR2 is also turned on, while the synchronous rectifier switch SR1 is turned off. When the high-voltage switch Q2 is turned on, the synchronous rectifier switch SR1 is also turned on, while the synchronous rectifier switch SR2 is turned off. When both high-voltage switches Q1 and Q2 are turned off, both synchronous rectifier switches SR1 and SR2 remain turned on for freewheeling. The connection modes of the other half-bridge circuits and the other low-voltage circuits are the same as those of the half-bridge circuit 1a and the low-voltage circuit 1b, respectively, and therefore will not be repeated herein.

The single-stage power conversion apparatus further includes (2N−1) auxiliary windings, namely T1a, T2a, T3a, . . . , T(2N−1)a. The (2N−1) auxiliary windings are electrically connected in series in sequence. That is, a second end of the first auxiliary winding T1a is electrically connected to a second end of the second auxiliary winding T2a; a first end of the second auxiliary winding T2a is electrically connected to a first end of the third auxiliary winding T3a; and so on, until a first end of the (2N−2)th auxiliary winding T(2N−2)a is electrically connected to a first end of the (2N−1)th auxiliary winding T(2N−1)a.

In other words, in the first (N−1) power sub-circuits, namely power sub-circuits 1 to (N−1), each power sub-circuit includes a first auxiliary winding and a second auxiliary winding, wherein the second end of the first auxiliary winding is electrically connected to the second end of the second auxiliary winding. Within the same power sub-circuit, one high-voltage winding, one low-voltage winding, and one auxiliary winding are coupled on one magnetic core to form one magnetic component, wherein the first end of the high-voltage winding, the first end of the low-voltage winding, and the first end of the auxiliary winding are corresponding polarity ends. A first end of the second auxiliary winding, namely the last auxiliary winding, in a preceding power sub-circuit is electrically connected to a first end of the first auxiliary winding in a subsequent power sub-circuit.

In detail, in power sub-circuit 1, the first high-voltage winding T1p, the first low-voltage winding T1s, and the first auxiliary winding T1a are coupled on one magnetic core to form a first magnetic component T1. The first end of the first high-voltage winding T1p, the first end of the first low-voltage winding T1s, and the first end of the first auxiliary winding T1a are corresponding polarity ends. The second high-voltage winding T2p, the second low-voltage winding T2s, and the second auxiliary winding T2a are coupled on one magnetic core to form a second magnetic component T2. The first end of the second high-voltage winding T2p, the first end of the second low-voltage winding T2s, and the first end of the second auxiliary winding T2a are corresponding polarity ends. In power sub-circuit 2, a first high-voltage winding T3p, a first low-voltage winding T3s, and a first auxiliary winding T3a are coupled on one magnetic core to form a first magnetic component T3. A first end of the first high-voltage winding T3p, a first end of the first low-voltage winding T3s, and a first end of the first auxiliary winding T3a are corresponding polarity ends. A second high-voltage winding T4p, a second low-voltage winding T4s, and a second auxiliary winding T4a are coupled on one magnetic core to form a second magnetic component T4. A first end of the second high-voltage winding T4p, a first end of the second low-voltage winding T4s, and a first end of the second auxiliary winding T4a are corresponding polarity ends. The first end of the second auxiliary winding T2a is electrically connected to the first end of the first auxiliary winding T3a.

In power sub-circuit N, only a first auxiliary winding T(2N−1)a is included. A first high-voltage winding T(2N−1)p, a first low-voltage winding T(2N−1)s, and the first auxiliary winding T(2N−1)a are coupled on one magnetic core to form a first magnetic component T(2N−1). A second high-voltage winding T(2N)p and a second low-voltage winding T(2N)s are coupled on one magnetic core to form a second magnetic component T2N. A first end of the first high-voltage winding T(2N−1)p, a first end of the first low-voltage winding T(2N−1)s, and a first end of the first auxiliary winding T(2N−1)a are corresponding polarity ends. A first end of the second low-voltage winding T(2N−1)s, and a first end of the second auxiliary winding T(2N−1)a are corresponding polarity ends. The first end of the first auxiliary winding T(2N−1)a is electrically connected to a first end of a second auxiliary winding T(2N−2)a. A second end of the first auxiliary winding T(2N−1)a is electrically connected to a second end of the second low-voltage winding T(2N)s, namely the last low-voltage winding in power sub-circuit N. The first end of the first auxiliary winding T1a is electrically connected to the first end of the second low-voltage winding T(2N)s. In the connection mode of the auxiliary windings described above, after the auxiliary windings are electrically connected in series in sequence, a closed loop is formed through the second low-voltage winding T(2N)s in power sub-circuit N.

In this embodiment, the first magnetic component and the second magnetic component in each power sub-circuit may be positively coupled, negatively coupled, or uncoupled from each other. By adding the auxiliary windings, steady-state inductance can be ensured so as to obtain reliable steady-state performance, and dynamic inductance can be reduced so as to satisfy the requirements of dynamic performance.

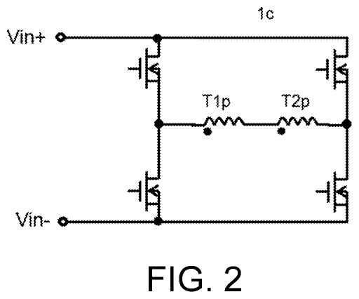

In another embodiment, the half-bridge circuit 1a may be replaced by a full-bridge circuit 1c, as shown in FIG. 2. The capacitor bridge arm is replaced by the switch bridge arm, and the high-voltage winding assembly is connected across the midpoints of the two switch bridge arms. Other technical features are the same as those in the embodiment shown in FIG. 1, and the technical effects shown in FIG. 1 can also be achieved.

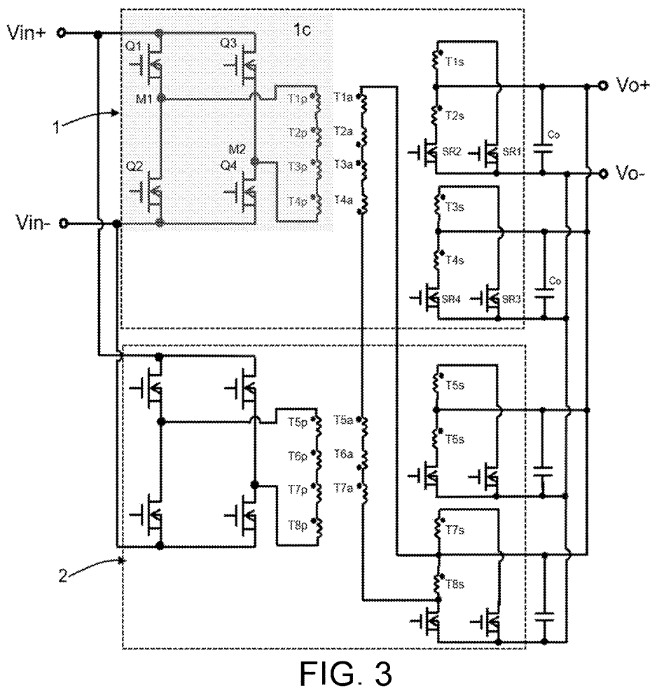

The present invention further illustrates another embodiment of the single-stage power conversion circuit, as shown in FIG. 3. For illustration, a single-stage power circuit including two power sub-circuits is taken as an example. The input terminals of the two power sub-circuits are electrically connected in parallel, and the output terminals thereof are electrically connected in parallel. Each power sub-circuit includes the full-bridge circuit 1c and two low-voltage circuits 1b. The full-bridge circuit 1c includes two switch bridge arms and one high-voltage winding assembly. The two switch bridge arms are electrically connected in parallel between an input positive terminal Vin+ and an input negative terminal Vin-. High-voltage switches Q1 and Q2 are electrically connected in series at a midpoint M1 of a first switch bridge arm, and high-voltage switches Q3 and Q4 are electrically connected in series at a midpoint M2 of a second switch bridge arm.

The high-voltage winding assembly is connected across the two switch bridge arm midpoints. In this embodiment, the high-voltage winding assembly includes high-voltage windings T1p, T2p, T3p, and T4p. The four high-voltage windings T1p&T2p&T3p&T4p are electrically connected in series in sequence and then connected across the switch bridge arm midpoints M1 and M2. A first end of the high-voltage winding T1p is electrically connected to the switch bridge arm midpoint M1; a second end of the high-voltage winding T1p is electrically connected to a first end of a high-voltage winding T2p; a second end of the high-voltage winding T2p is electrically connected to a first end of the high-voltage winding T3p; a second end of the high-voltage winding T3p is electrically connected to a first end of the high-voltage winding T4p; and a second end of the high-voltage winding T4p is electrically connected to the switch bridge arm midpoint M2.

A first low-voltage circuit 1b includes synchronous rectifier switches SR1 and SR2, a first low-voltage winding T1s, and a second low-voltage winding T2s. A second low-voltage circuit 1b includes synchronous rectifier switches SR3 and SR4, a third low-voltage winding T3s, and a fourth low-voltage winding T4s. The two low-voltage circuits 1b are connected in the same manner as the low-voltage circuit 1b in FIG. 1, and therefore details will not be repeated herein.

Without considering dead-time settings of gate drive signals, when the high-voltage switches Q1 and Q4 are turned on, the synchronous rectifier switches SR2 and SR4 are also turned on, while the synchronous rectifier switches SR1 and SR3 are turned off. When the high-voltage switches Q3 and Q2 are turned on, the synchronous rectifier switches SR1 and SR3 are also turned on, while the synchronous rectifier switches SR2 and SR4 are turned off. When the high-voltage switches Q1, Q2, Q3, and Q4 are all turned off, the synchronous rectifier switches SR1, SR2, SR3, and SR4 all remain turned on for freewheeling.

The single-stage power conversion apparatus further includes seven auxiliary windings, namely T1a, T2a, T3a, . . . , T7a. In power sub-circuit 1, the first high-voltage winding T1p, the first low-voltage winding T1s, and the first auxiliary winding T1a are coupled on one magnetic core to form a first magnetic component T1. A first end of the first high-voltage winding T1p, a first end of the first low-voltage winding T1s, and a first end of the first auxiliary winding T1a are corresponding polarity ends. The second high-voltage winding T2p, the second low-voltage winding T2s, and the second auxiliary winding T2a are coupled on one magnetic core to form a second magnetic component T2. The first end of the second high-voltage winding T2p, a first end of the second low-voltage winding T2s, and a first end of the second auxiliary winding T2a are corresponding polarity ends. The third high-voltage winding T3p, the third low-voltage winding T3s, and the third auxiliary winding T3a are coupled on one magnetic core to form a third magnetic component T3. The first end of the third high-voltage winding T3p, a first end of the third low-voltage winding T3s, and a first end of the third auxiliary winding T3a are corresponding polarity ends. The fourth high-voltage winding T4p, the fourth low-voltage winding T4s, and a fourth auxiliary winding T4a are coupled on one magnetic core to form a fourth magnetic component T4. The first end of the fourth high-voltage winding T4p, a first end of the fourth low-voltage winding T4s, and a first end of the fourth auxiliary winding T4a are corresponding polarity ends.

The seven auxiliary windings are electrically connected in series in sequence. That is, a second end of the first auxiliary winding T1a is electrically connected to a second end of the second auxiliary winding T2a; the first end of the second auxiliary winding T2a is electrically connected to the first end of the third auxiliary winding T3a; and so on, until a second end of a fifth auxiliary winding T5a is electrically connected to a second end of a sixth auxiliary winding T6a, and a first end of the sixth auxiliary winding T6a is electrically connected to a first end of a seventh auxiliary winding T7a.

In power sub-circuit 2, a first high-voltage winding T5p, a first low-voltage winding T5s, and a fifth auxiliary winding T5a are coupled on one magnetic core to form a first magnetic component T5. A first end of the first high-voltage winding T5p, a first end of the first low-voltage winding T5s, and a first end of the fifth auxiliary winding T5a are corresponding polarity ends. A second high-voltage winding T6p, a second low-voltage winding T6s, and a sixth auxiliary winding T6a are coupled on one magnetic core to form a second magnetic component T6. A first end of the second high-voltage winding T6p, a first end of the second low-voltage winding T6s, and a first end of the sixth auxiliary winding T6a are corresponding polarity ends. By analogy, in power sub-circuit 2, a third high-voltage winding T7p, a third low-voltage winding T7s, and a seventh auxiliary winding T7a are coupled on one magnetic core to form a third magnetic component T7, and a first end of the third high-voltage winding T7p, a first end of the third low-voltage winding T7s, and a first end of the seventh auxiliary winding T7a are corresponding polarity ends.

The first end of the first auxiliary winding T1a is electrically connected to a first end of a fourth low-voltage winding T8s, and a second end of the seventh auxiliary winding T7a is electrically connected to a second end of the fourth low-voltage winding T8s. In the connection mode of the auxiliary windings described above, after the auxiliary windings are electrically connected in series in sequence, a closed loop is formed through the fourth low-voltage winding T8s in power sub-circuit 2.

Similarly, the single-stage power conversion circuit shown in FIG. 3 may include N power sub-circuits. The N power sub-circuits may adopt the same connection mode and technical features as those in the embodiment shown in FIG. 3, and the same technical effects can likewise be achieved. In this embodiment, the first magnetic component and the second magnetic component in each power sub-circuit may be positively coupled, negatively coupled, or uncoupled from each other. The third magnetic component and the fourth magnetic component may also be positively coupled, negatively coupled, or uncoupled from each other. By adding the auxiliary winding(s), the steady-state inductance of the single-stage power conversion circuit can be ensured so as to obtain reliable steady-state performance, and the dynamic inductance can be reduced so as to satisfy the requirements of dynamic performance.

Further, each power sub-circuit may comprise M low-voltage circuits 1b, where M is an integer greater than 2. Correspondingly, each high-voltage winding assembly comprises 2M high-voltage windings, and the 2M high-voltage windings are electrically connected in series in sequence. The single-stage power conversion circuit further comprises (N*M−1) auxiliary windings, and the connection mode of the auxiliary windings is the same as that in the foregoing embodiments; and the coupling mode of the high-voltage windings, the low-voltage windings, and the auxiliary windings, and the coupling mode of the high-voltage windings and the low-voltage winding are with reference to the foregoing embodiments.

In the embodiments disclosed herein, the input negative terminal and the output negative terminal may be short-circuited, and the above auxiliary windings may likewise be added so as to achieve the same technical effects.

The switching devices disclosed herein may be Si MOSFETs, SiC MOSFETs, GaN MOSFETs, IGBT devices, or the like, all of which can implement the switching functions disclosed in the present invention.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A power conversion apparatus, comprising:
a high-voltage circuit and N low-voltage circuits, wherein N is an integer greater than or equal to 2;
wherein the high-voltage circuit comprises high-voltage windings and high-voltage switches, wherein the number of the high-voltage windings is 2N;
wherein each of the N low-voltage circuits comprises a low-voltage winding and a low-voltage switch, the low-voltage winding comprises a first low-voltage winding and a second low-voltage winding electrically connected in series;
wherein the power conversion apparatus further comprising auxiliary windings,
wherein the number of the auxiliary windings is (2N−1), and the (2N−1) auxiliary windings are electrically connected in series in sequence to form an auxiliary winding branch;
wherein one of the high-voltage windings, one of the first low-voltage windings, and one of the auxiliary windings are coupled to form a first transformer;
wherein another one of the high-voltage windings, another one of the second low-voltage windings, and another one of the auxiliary windings are coupled to form a second transformer; and
wherein still another one of the high-voltage windings and still another one of the second low-voltage windings are coupled to form a third transformer.

2. The power conversion apparatus according to claim 1, wherein the auxiliary winding branch and the second low-voltage winding in the third transformer are connected in series to form an auxiliary winding series loop.

3. The power conversion apparatus according to claim 1, wherein the low-voltage circuit comprises a low-voltage terminal, the low-voltage terminal comprises a low-voltage positive terminal and a low-voltage negative terminal;
wherein a series connection point between the first low-voltage winding and the second low-voltage winding is electrically connected to the low-voltage positive terminal, and the first low-voltage winding and the second low-voltage winding are electrically connected to the low-voltage negative terminal through the low-voltage switch.

4. The power conversion apparatus according to claim 3, wherein the N low-voltage circuits are electrically connected in parallel and connected across the low-voltage positive terminal and the low-voltage negative terminal.

5. The power conversion apparatus according to claim 1, wherein the high-voltage circuit comprises M high-voltage sub-circuits, M being an integer greater than or equal to 1;
wherein each of the M high-voltage sub-circuits comprises 2×N/M high-voltage windings and two high-voltage bridge arms, each of the two high-voltage bridge arms comprises a bridge arm midpoint, and the 2×N/M high-voltage windings being electrically connected in series and connected across the bridge arm midpoints of the two high-voltage bridge arms.

6. The power conversion apparatus according to claim 5, wherein the power conversion apparatus comprises a high-voltage terminal, the high-voltage terminal comprises a high-voltage positive terminal and a high-voltage negative terminal, and the M high-voltage sub-circuits are electrically connected in parallel and connected across the high-voltage positive terminal and the high-voltage negative terminal.

7. The power conversion apparatus according to claim 5, wherein the high-voltage bridge arms are respectively a switch bridge arm and a capacitor bridge arm, the switch bridge arm comprises two high-voltage switches connected in series, and the capacitor bridge arm comprises two capacitors connected in series.

8. The power conversion apparatus according to claim 5, wherein the high-voltage bridge arms are switch bridge arms, and each switch bridge arm comprises two high-voltage switches connected in series.

9. The power conversion apparatus according to claim 5, wherein, in the first transformer, a first end of the high-voltage winding, a first end of the first low-voltage winding, and a first end of the auxiliary winding are corresponding polarity ends;
wherein, in the second transformer, a first end of the high-voltage winding, a first end of the second low-voltage winding, and a first end of the auxiliary winding are corresponding polarity ends;
wherein, in the third transformer, a first end of the high-voltage winding and a first end of the second low-voltage winding are corresponding polarity ends.

10. The power conversion apparatus according to claim 9, wherein among the 2×N/M high-voltage windings connected in series, the high-voltage windings located at two ends of the series loop are respectively a first high-voltage winding and a second high-voltage winding; a first end of the first high-voltage winding and a second end of the second high-voltage winding are respectively electrically connected to the bridge arm midpoint;
wherein a second end of the first high-voltage winding is electrically connected to a first end of an adjacent high-voltage winding, and a first end of the second high-voltage winding is electrically connected to a second end of an adjacent high-voltage winding;
wherein a second end of the first low-voltage winding is electrically connected to the first end of the second low-voltage winding.

11. The power conversion apparatus according to claim 10, wherein the auxiliary winding in the first transformer is a first auxiliary winding, and the auxiliary winding in the second transformer is a second auxiliary winding;
wherein the (2N−1) auxiliary windings are electrically connected in series to form a series branch in the order of the first auxiliary winding, the second auxiliary winding, and the first auxiliary winding, wherein the first auxiliary windings located at two ends of the series branch of the (2N−1) auxiliary windings are respectively an upper first auxiliary winding and a lower first auxiliary winding;
wherein a second end of the upper first auxiliary winding is short-circuited to a second end of the second auxiliary winding, and a first end of the lower first auxiliary winding is short-circuited to a first end of the second auxiliary winding;
for the first auxiliary winding located between the upper first auxiliary winding and the lower first auxiliary winding, a first end thereof is short-circuited to the first end of the second auxiliary winding, and a second end thereof is short-circuited to the second end of the second auxiliary winding.

12. The power conversion apparatus according to claim 11, wherein a second end of the lower first auxiliary winding is short-circuited to a second end of one second low-voltage winding, and the first end of the second low-voltage winding is short-circuited to a first end of the upper first auxiliary winding; the second low-voltage winding and the first low-voltage winding of the third transformer are in a same low-voltage circuit.

13. A power conversion apparatus, comprising:
an input positive terminal, an input negative terminal, an output positive terminal, an output negative terminal, and N power sub-circuits, each of the N power sub-circuits comprising a high-voltage circuit, a low-voltage circuit, and auxiliary windings, wherein N is an integer greater than or equal to 2;
wherein the high-voltage circuit is connected across the input positive terminal and the input negative terminal, and comprises a high-voltage switch assembly and a high-voltage winding assembly; the high-voltage switch assembly comprises at least two high-voltage switches, and each of the high-voltage switches is electrically connected to the high-voltage winding assembly; the high-voltage winding assembly comprises a first high-voltage winding and a second high-voltage winding, and a second end of the first high-voltage winding is electrically connected to a first end of the second high-voltage winding;
wherein the low-voltage circuit is connected across the output positive terminal and the output negative terminal, and comprises a low-voltage switch assembly and a low-voltage winding assembly; the low-voltage switch assembly comprises at least two low-voltage switches, and each of the low-voltage switches is electrically connected to the low-voltage winding assembly; the low-voltage winding assembly comprises a first low-voltage winding and a second low-voltage winding, and a second end of the first low-voltage winding is electrically connected to a first end of the second low-voltage winding;
wherein each of the N power sub-circuits from the first power sub-circuit to the (N−1)th power sub-circuit further comprises a first auxiliary winding and a second auxiliary winding; a second end of the first auxiliary winding is electrically connected to a second end of the second auxiliary winding; a first end of the last auxiliary winding in the Kth power sub-circuit is electrically connected to a first end of the first auxiliary winding in the (K+1)th power sub-circuit, where 1≤K≤(N−1);
wherein the first high-voltage winding, the first low-voltage winding, and the first auxiliary winding are coupled to form a first transformer;
the second high-voltage winding, the second low-voltage winding, and the second auxiliary winding are coupled to form a second transformer.

14. The power conversion apparatus according to claim 13, wherein the Nth power sub-circuit comprises a first auxiliary winding,
wherein a first end of the first auxiliary winding in the Nth power sub-circuit being electrically connected to a first end of the last auxiliary winding in the (N−1)th power sub-circuit, and a second end of the first auxiliary winding in the Nth power sub-circuit being electrically connected to a second end of the second low-voltage winding in the Nth power sub-circuit;
wherein a first end of the first auxiliary winding in the first power sub-circuit is electrically connected to the first end of the second low-voltage winding in the Nth power sub-circuit; the first high-voltage winding, the first low-voltage winding, and the first auxiliary winding are coupled to form one transformer; and the second high-voltage winding and the second low-voltage winding in the Nth power sub-circuit are coupled to form one transformer.

15. The power conversion apparatus according to claim 14, wherein the high-voltage switch assembly comprises four high-voltage switches, the four high-voltage switches forming two switch bridge arms, the two switch bridge arms being electrically connected in parallel;
wherein a first end of the first high-voltage winding and a second end of the second high-voltage winding are respectively electrically connected to a bridge arm midpoint;
and in the same transformer, a first end of the high-voltage winding, a first end of the low-voltage winding, and a first end of the auxiliary winding are corresponding polarity ends.

16. The power conversion apparatus according to claim 14, wherein the high-voltage circuit is a half-bridge circuit, and the half-bridge circuit comprises two series bridge arms, wherein the two series bridge arms comprise a capacitor bridge arm and a switch bridge arm;
wherein the capacitor bridge arm comprises two capacitors, the two capacitors being electrically connected in series at a capacitor bridge arm midpoint;
the switch bridge arm comprises two switches, the two switches being electrically connected in series at a switch bridge arm midpoint; and
the high-voltage winding assembly is connected across the capacitor bridge arm midpoint and the switch bridge arm midpoint.

17. The power conversion apparatus according to claim 13, wherein the low-voltage circuit is a first low-voltage circuit, and each of the N power sub-circuits further comprises a second low-voltage circuit;
the second low-voltage circuit comprises a third low-voltage winding, a fourth low-voltage winding, a third low-voltage switch, and a fourth low-voltage switch;
a first end of the third low-voltage winding is electrically connected to the third low-voltage switch, a second end of the third low-voltage winding and a first end of the fourth low-voltage winding are electrically connected to the output positive terminal, and a second end of the fourth low-voltage winding is electrically connected to the fourth low-voltage switch; and
the third low-voltage switch and the fourth low-voltage switch are electrically connected to the output negative terminal.

18. The power conversion apparatus according to claim 17, wherein the high-voltage winding assembly in each of the N power sub-circuits further comprises a third high-voltage winding and a fourth high-voltage winding;
wherein a second end of the second high-voltage winding is electrically connected to a first end of the third high-voltage winding, a second end of the third high-voltage winding is electrically connected to a first end of the fourth high-voltage winding, the high-voltage circuit comprises two series bridge arms, each of the series bridge arms comprises a bridge arm midpoint; a first end of the first high-voltage winding and a second end of the fourth high-voltage winding are respectively electrically connected to one bridge arm midpoint.

19. The power conversion apparatus according to claim 18, wherein each of the N power sub-circuits from the first power sub-circuit to the (N−1)th power sub-circuit further comprises a third auxiliary winding and a fourth auxiliary winding;
a first end of the second auxiliary winding is electrically connected to a first end of the third auxiliary winding, and a second end of the third auxiliary winding is electrically connected to a second end of the fourth auxiliary winding;
a first end of the last auxiliary winding in the Kth power sub-circuit is electrically connected to a first end of the first auxiliary winding in the (K+1)th power sub-circuit;
wherein the third high-voltage winding, the third low-voltage winding, and the third auxiliary winding are coupled to form a third transformer;
the fourth high-voltage winding, the fourth low-voltage winding, and the fourth auxiliary winding are coupled to form a fourth transformer;
wherein the Nth power sub-circuit comprises a first auxiliary winding, a second auxiliary winding and a third auxiliary winding;
a second end of the first auxiliary winding is electrically connected to a second end of the second auxiliary winding; a first end of the second auxiliary winding is electrically connected to a first end of the third auxiliary winding;
a second end of the third auxiliary winding is electrically connected to a second end of the fourth low-voltage winding in the Nth power sub-circuit; and
a first end of the first auxiliary winding in the first power sub-circuit is electrically connected to a first end of the fourth low-voltage winding in the Nth power sub-circuit;
wherein the fourth high-voltage winding and the fourth low-voltage winding are coupled to form a fifth transformer.

20. The power conversion apparatus according to claim 19, wherein each of the N power sub-circuits further comprises a third low-voltage circuit, or comprises the third low-voltage circuit to an Mth low-voltage circuit, where M is an integer greater than 2;
wherein the high-voltage winding assembly in the high-voltage circuit further comprises M high-voltage windings, the M high-voltage windings being electrically connected in series in sequence;
each of the N power sub-circuits comprises (2M−1) auxiliary windings; and
one high-voltage winding, one low-voltage winding and one auxiliary winding are coupled to form one transformer or one high-voltage winding and one low-voltage winding are coupled to form one transformer.
